(19) United States
(12) Patent Application Publication
(10) Pub. No.: US 2003/0093703 A1
(43) Pub. Date: May 15, 2003

(54) Multiple dataport clock synchronization

(75) Inventors: Jeffrey Oliver, Tustin, CA (US); Craig Evensen, Trabuco Canyon, CA (US)

Correspondence Address: Fogg, Slifer & Polglaze, P.A., P.O. Box 581009, Minneapolis, MN, 55458-1009, US

(73) Assignee: ADC DSL Systems, Inc.

(21) Appl. No.: 10/007,775

(22) Filed: Nov. 9, 2001

(51) Int. Cl. G06F 13/42; H04L 7/00; H04L 5/00; G06F 1/12

(52) U.S. Cl. 713/400

(57) ABSTRACT

A communications device apparatus and method is detailed that allows for improved operation and reduced costs of network communication links and datastreams with an improved ability to merge and synchronize multiple WAN and LAN dataport datastreams. The improved communications device apparatus and method allows for a master data clock selection, a clock recovery, a derivate data clock division and a dataport data clock selection that allows for the generation of one or more synchronous derivative data clocks and the merging of multiple dataport datastreams for data transceiving. The improved communications device apparatus and method also allows for a master data clock to be recovered from a selected dataport and the other differing data rate dataports to be synchronized to it for the merging of multiple dataport datastreams for data transceiving.

### TECHNICAL FIELD

The present invention relates generally to communications devices and in particular the present invention relates to synchronization of multiple dataports in communications devices.

### BACKGROUND

Modern networks and network systems are typically constructed of multiple differing devices, elements, or links, referred to collectively herein as elements. These elements include communications devices that connect networks and other elements across a link. Links can be virtual links that connect through other communications devices or physical links that connect across physical wire, cables, wireless, or optical connections. Links can be of multiple protocols and physical connections and signaling methods. Telecommunications devices are specialized communications devices that connect networks and elements across links that are part of a telecommunications or phone system. Examples of such include, but are not limited to, digital subscriber line (DSL), ethernet links, modems, token ring, network hubs, network switches, wide area network (WAN) bridges, integrated services digital network (ISDN) devices, T1 termination units, etc. In particular, one recent such communications link and protocol is global symmetric high-speed digital subscriber line (G.SHDSL, or G.991.2) promulgated by the international telecommunication union (ITU).

Communications devices can have many physical configurations and implementations. Two popular physical configurations are the standalone enclosure and the line card chassis. Standalone enclosures are typically used at end user sites or link terminal sites where only one device is required. Line card chassis are popular in network hubs or telecommunication offices where multiple communication links end and the density and central management capability of a line card chassis is an advantage.

Many communications devices have at least one other dataport or interface that are associated with the device. The other dataports associated with a communications device can be coupled to multiple local networks or to other large data bandwidth or long distance communication links that can be of differing protocols. The dataport(s) with the high data bandwidth or long distance link are typically known as the wide area network (WAN) dataports, and the dataports associated with local networks are known generally as the local area network (LAN) dataports. These dataports are usually coupled in various manners through the communications device to allow them to communicate data with each other.

In many situations datastreams from two or more dataports need to be merged to send through the communications link of another dataport, typically a WAN dataport. Alternatively, the datastream of a single dataport needs to be split to send out two or more other dataports. The process of sending (transmitting) and receiving through a dataport or interface is generally known as transceiving.

Many modern dataports or interfaces and the driving chipsets or communication protocols that are utilized through them are synchronous in that they send or receive data in a datastream that is synchronized to a clock source. To send or receive data at a dataport the datastream needs to be organized in an orderly manner so as to prevent an overrun condition (too much data) or an underrun (too little data) at the sending port. If this requires the merging of two or more other datastreams to send through the dataport, or if the dataport is synchronous, the issue is even more problematic. A typical solution to this issue is to add a first-in-first-out (FIFO) buffer to the datastream. Because of the speed and size requirement of a FIFO that can handle the datastream of a modern communications link and the complexity and potential timing issues the use of a FIFO in merging and/or synchronizing one or more datastreams can be an expensive solution.

For the reasons stated above, and for other reasons stated below which will become apparent to those skilled in the art upon reading and understanding the present specification, there is a need in the art for a method and apparatus of conveniently buffering and merging dataport datastreams in communications devices without complex protocols or FIFOs to allow multiple connections and full bandwidth use of communications devices in a network environment.

### SUMMARY

The above-mentioned problems with conveniently buffering and merging dataport datastreams in communications devices without complex protocols or FIFOs to allow multiple connections and full bandwidth use of communications devices in a network environment are addressed by embodiments of the present invention and will be understood by reading and studying the following specification.

In one embodiment, a method of operating a telecommunications device with a plurality of dataports includes selecting a master clock signal from at least one clock source, generating a synchronized reference clock signal from the master clock signal, dividing the synchronized reference clock signal to generate at least one synchronized derivative clock signal, coupling each at least one synchronized derivative clock signal to one or more of the plurality of dataports, and transceiving data synchronized to the master clock signal on each of the plurality of dataports.

In another embodiment, a method of operating a telecommunications device with a plurality of dataports includes selecting a master clock signal from at least one clock source, dividing the master clock signal to generate at least one derivative clock signal, synchronizing each of the at least one derivative clock signal to the master clock signal, coupling each at least one synchronized derivative clock signal to one or more of the plurality of dataports, and transceiving data synchronized to the master clock signal on each of the plurality of dataports.

In yet another embodiment, a method of operating a communications device with a plurality of dataports includes recovering a master clock signal from a source dataport, generating a synchronized reference clock signal from the master clock signal, dividing the synchronized reference clock signal to generate at least one synchronized derivative clock signal, coupling each at least one synchronized derivative clock signal to one or more of the plurality of dataports, and transceiving data synchronized to the master clock signal on each of the plurality of dataports.

In a further embodiment, a method of operating a G.SHDSL device includes recovering a master clock signal from a first dataport, deriving a synchronized clock signal from the master clock signal, coupling the synchronized clock signal to a second dataport, transceiving data on the first dataport, and transceiving data synchronized to the master clock signal of the first dataport on the second dataport.

In yet a further embodiment, a machine-usable medium has machine readable instructions stored thereon for execution by a processor of a telecommunications device to perform a method. The method includes receiving a master clock signal from a clock source, deriving at least one synchronized clock signal from the master clock signal, coupling each at least one synchronized clock signal to one or more of the plurality of dataports, and transceiving data synchronized to the master clock signal on each of the plurality of dataports.

In another embodiment, a communications device includes a plurality of local interfaces, and a master clock source, where at least one synchronized clock signal is generated from the master clock source and where each at least one generated synchronized clock signal coupled to one or more of the plurality of local interfaces to transceive data synchronized to the master clock source on each of the plurality of local interfaces.

In yet another embodiment, a telecommunications device includes a plurality of local interfaces, and a source clock, where the source clock is recovered from a local interface of the plurality of local interfaces and at least one synchronized clock signal is generated from the source clock and coupled to one or more of the plurality of local interfaces to transceive data synchronized to the source clock on each of the plurality of local interfaces.

In a further embodiment, a G.SHDSL communications device, includes a G.SHDSL interface, a V.35 interface, and a E1 interface, where a source clock is recovered from the E1 interface and a synchronized clock signal is generated from the source clock and coupled to V.35 interface to transceive data synchronized to the source clock of the E1 interface, where data transceived from the E1 and V.35 interfaces is transceived to the G.SHDSL interface.

In yet a further embodiment, a telecommunications device has a plurality of local interfaces, and an external interface coupled to the plurality of local interfaces, and a multiple interface clock synchronization method. The multiple interface clock synchronization method includes receiving a master clock signal from a clock source, deriving at least one synchronized clock signal from the master clock signal, coupling each at least one synchronized clock signal to one or more of the plurality of dataports, and transceiving data synchronized to the master clock signal on each of the plurality of dataports.

Other embodiments are described and claimed.

### BRIEF DESCRIPTION OF THE DRAWINGS

FIG. 1 is a simplified diagram of a communication link with communications devices.

FIGS. 2A and 2B are simplified diagrams of a WorldDSL G.SHDSL compatible modem.

FIG. 3 is a simplified diagram of a field programmable gate array (FPGA) and design.

FIG. 4 is a simplified diagram of a clock selection and processing circuit.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include communications devices that select a master clock source, recover a reference clock from the master clock source, divide the reference clock to produce differing but synchronous derivative clock signals, and utilize the synchronous derivative clock signals to drive one or more dataports of the communications device to deliver synchronous transceived datastreams. Embodiments of the present invention also include communications devices that recover a master clock source from a synchronous dataport and recover a reference clock from the master clock source, divide the reference clock to produce differing but synchronous derivative clock signals, and utilize the synchronous derivative clock signals to drive one or more dataports of the communications device to deliver synchronous transceived datastreams. Embodiments of the present invention additionally include G.SHDSL devices that recover a master clock source from a synchronous dataport or select a master clock source from one or more clock sources and recover a reference clock from the master clock source, divide the reference clock to produce differing but synchronous derivative clock signals, and utilize the synchronous derivative clock signals to drive one or more dataports of the communications device to deliver synchronous transceived datastreams.

As stated above, merging datastreams from differing dataports or interfaces in a communications device is a difficult task. The WAN and LAN dataports connected to a communications device are generally specific to the device's purpose and operation. The datastreams to be managed by the communications device therefore are specific to the type of communications device and the specific dataports being utilized in operation. Many dataports in modern communications devices are synchronous or have the ability to accept a clock signal or data clock to clock its datastream at. Therefore in situations where a series of synchronous dataports or dataports that can accept a clock input are utilized by the communications device the dataports can be clocked by data clocks that are synchronous with the selected master clock to produce a unified synchronous datastream. If a master clock source signal is divided down, synchronous data clocks of differing data rates can be produced. The synchronous data clocks of differing datastream data rates still allow for a merged synchronous datastream to be generated easily with the use of the appropriate logic, such as field programmable gate arrays (FPGA), application specific integrated chip (ASIC), or communications device chipset. This merging of synchronous datastreams of differing data rates is well understood and will be apparent to those skilled in the art with the benefit the present specification.

Communications devices of the present invention utilize multiple clock sources to synchronize dataport datastreams in various embodiments. These clock sources include, but are not limited to externally provided clock sources, network chassis generated clock sources, internally generated clock sources, and clocks recovered from communication links through the associated dataport. In one embodiment, the communications device selects the master clock source on initialization according to its saved configuration or in response to a configuration request given by an administrator or management program.

In many cases a dataport, while synchronous in operation, does not allow for the input of a synchronizing data clock to clock its datastream to. In these situations, communications device embodiments of the present invention select the dataport as the master clock source and synchronize the other required dataports to it.

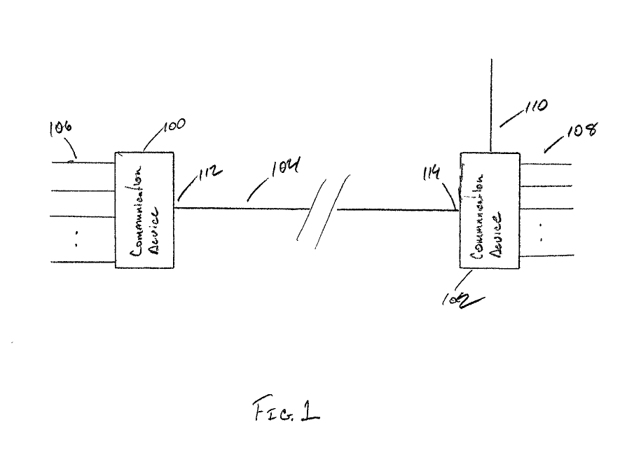

FIG. 1 details a simplified block diagram of two communications devices 100, 102 coupled by a communications link 104 through their WAN dataports 112, 114. Each communications device 100, 102 has one or more local LAN dataports 106, 108 and/or additional WAN dataports 110.

A G.SHDSL communications device is one such communications device that can benefit from merging datastreams. The G.SHDSL requirements for the transmission and multiplexing of data over a single pair of wires allow the data rate on the single pair of wires to be selectable from the rates specified in the G.SHDSL requirements, presently supporting user data rates between 192 Kbps and 2304 Kbps. Two interfaces for user data may be provided—one E1 G.703/704 dataport and one serial dataport (V.35NV.36/RS530/RS-449/X.21). The E1 dataport generally operates at a bit rate of 2048 Kbps, but anywhere from 0 to 32 of the 32 available timeslots may actually be transmitted across the aggregate data link. The dataport may operate at a rate of (n×64 Kbps) where 1≦n≦36. The aggregate datastream may be composed of both E1 and dataport user data where aggregate data bandwidth is allocated in multiples of 64 Kbps. This permits an entire 32 time slot E1 data stream and a 256 Kbps data port stream to be transmitted over one pair of wires at the maximum G.SHDSL data rate. As the aggregate data rate is reduced, the amount of user data transmitted across the data link must also be reduced.

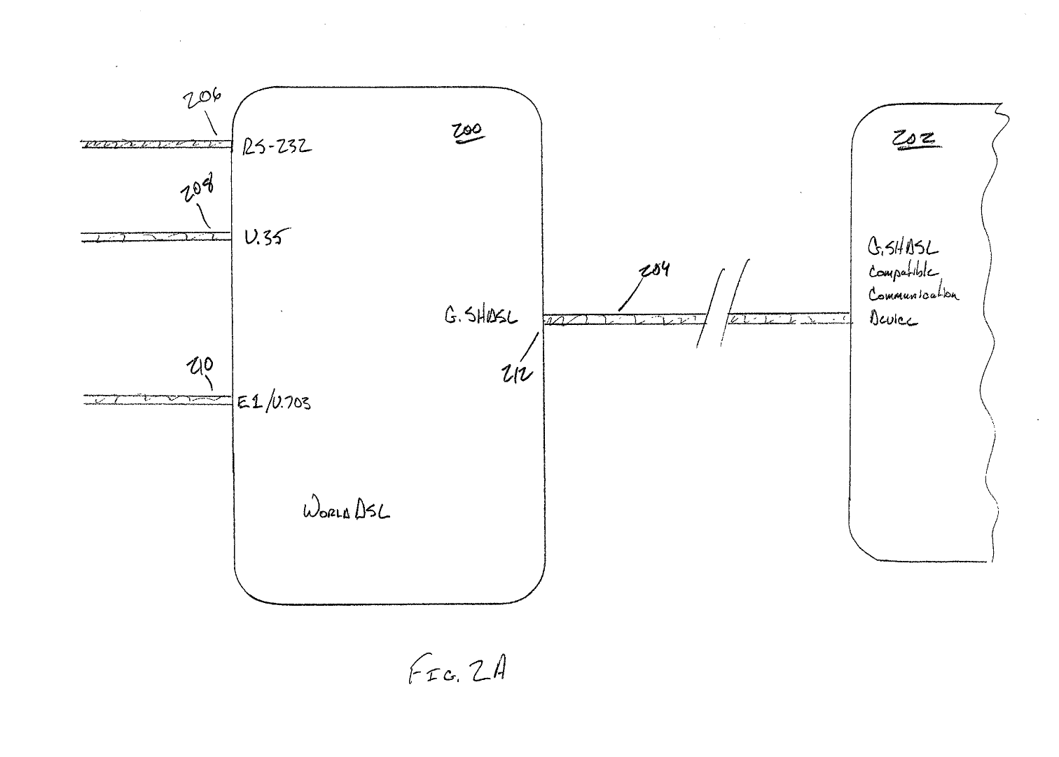

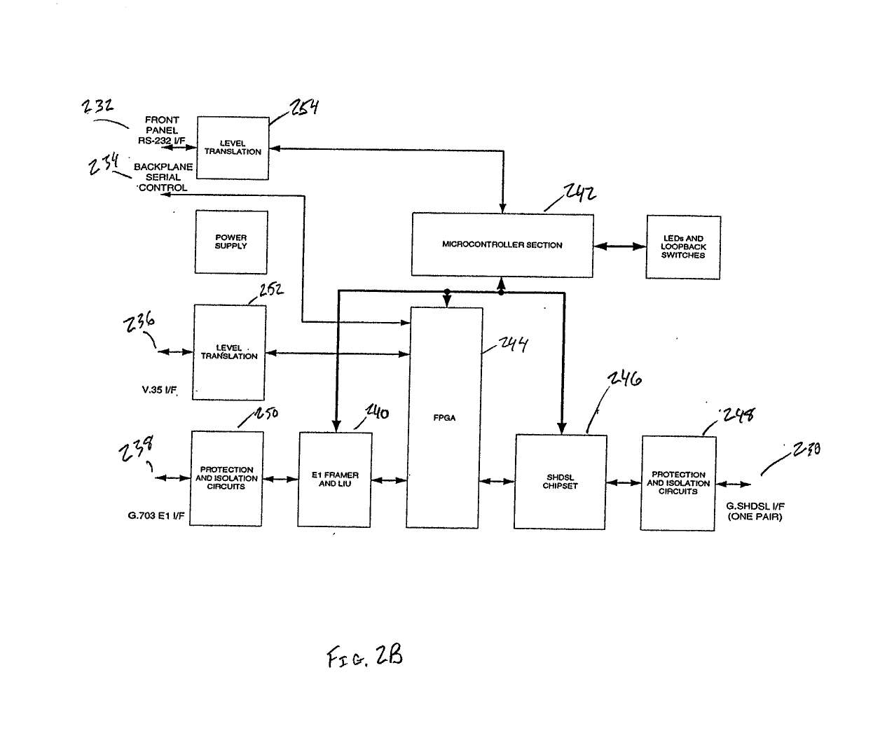

FIG. 2A details a simplified block diagram of one embodiment of a G.SHDSL modem 200 made by ADC Telecommunications, Inc. Eden Prairie, Minn. The G.SHDSL modem 200 of FIG. 2A is detailed coupled to a G.SHDSL compatible communications device 202 through a G.SHDSL communications link 204. The G.SHDSL modem 200 contains several dataports that include a serial (RS-232) dataport 206, a V.35 dataport 208, and an E1 dataport 210. The G.SHDSL modem 200 also includes a G.SHDSL WAN dataport 212 that is coupled to the G.SHDSL communications link 204.

The G.SHDSL modem 200 of FIG. 2A can be physically implemented in several forms and configurations. One such implementation is as a standalone unit with its own enclosure and power supply. Another such unit is as a line card in a G.SHDSL network card chassis with a shared power supply, chassis backplane communication connections, and chassis card management.

FIG. 2B details a simplified embodiment of a G.SHDSL modem internal block diagram which contains a G.SHDSL dataport 230, a front panel RS-232 dataport 232, a backplane serial control dataport 234, a V.35 dataport 236, an E1 dataport 238, an E1 framer and line interface unit (LIU) 240, a processor, a FPGA 244, a G.SHDSL chipset 246 (typically a Conexant, Inc. of Newport Beach, Calif. Mindspeed TM chipset (CX28975)), dataport isolation circuits 248, 250, and level translation circuits 252, 254. In the simplified WorldDSL G.SHDSL modem internal block diagram of FIG. 2B, the G.SHDSL chipset 246 is coupled through a protection and isolation circuit 248 and drives the G.SHDSL dataport 230. The G.SHDSL chipset 246 in turn is coupled to the FPGA 244. In addition to the G.SHDSL chipset 246, the FPGA 244 is coupled to the backplane serial control dataport 234, the V.35 dataport 236 through the level translation circuit 252, and the E1 framer and LIU circuit 240. The E1 framer and LIU circuit 240 in turn is coupled to the E1 dataport 238 through the protection and isolation circuit 250. The front panel RS-232 dataport 232 is coupled to the processor 242 through the level translation circuit 254. The processor 242 is additionally coupled to the E1 framer and LIU circuit 240, the FPGA 244, and the G.SHDSL chipset 246.

In operation of the G.SHDSL modem of FIG. 2, data is transceived in and out of the G.SHDSL WAN dataport 230 by the G.SHDSL chipset 246. The datastream transceived from the G.SHDSL WAN dataport 230 by the G.SHDSL chipset 246 is processed by the FPGA 244, which couples it to the E1 dataport 238 through the E1 framer and LIU 240, the V.35 dataport 236, or to both dataports simultaneously. The processor 242 monitors and controls the initialization, configuration, and operation of the E1 framer and LIU 240, the FPGA 244, and the G.SHDSL chipset 246, configuring and monitoring the operation of the dataports 236, 238, 230, 234, 232 and the associated datastreams.

In the monitoring and control of the initialization, configuration, and operation of the G.SHDSL modem the processor 242 may contain a storage element or storage medium (not shown) that is in one embodiment a computer-readable or machine-usable media. Computer-readable or machine-usable media is defined for the purposes of this disclosure as a set of computer-readable instructions stored on a computer-usable medium for execution by a processor. Examples of computer-usable media include, but are not limited to, removable and non-removable magnetic media, optical media, dynamic random-access memory (DRAM), static random-access memory (SRAM), read-only memory (ROM) and electrically-erasable and programmable read-only memory (EEPROM or Flash). It is noted that communications devices can take multiple other physical forms, including, but not limited to, communications devices that are functions of other network elements, or network elements that have the communications device functionality expressed in firmware or even hard-coded in a device such as an application-specific integrated circuit (ASIC) chip.

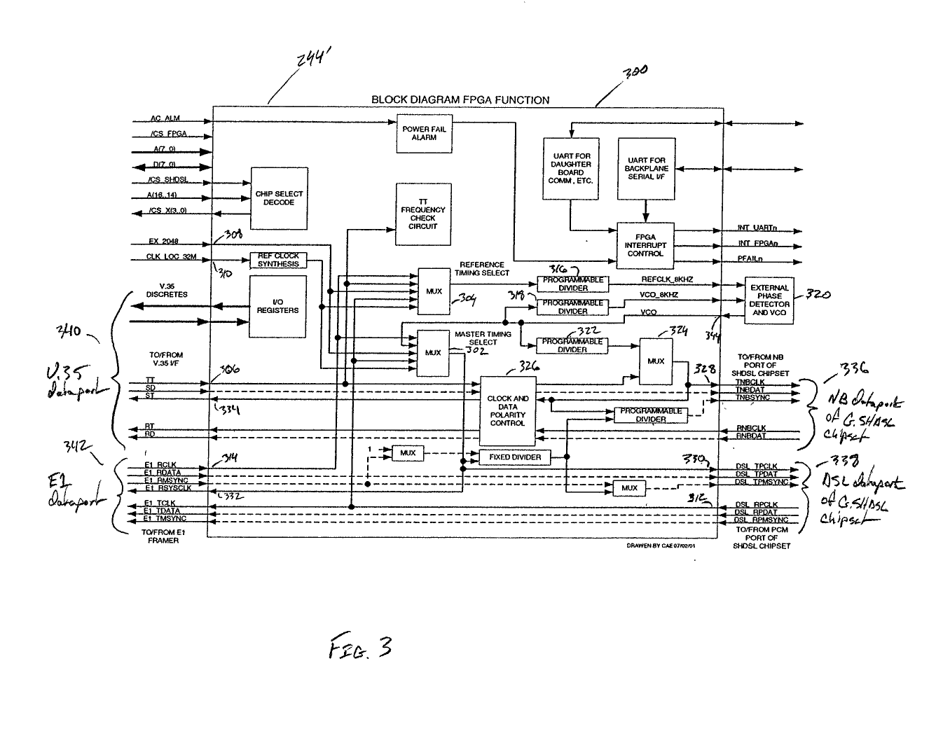

FIG. 3 details a simplified block diagram of an embodiment of an FPGA such as the FPGA 300, 244′. The FPGA 300 for clock generation contains a master clock select multiplexer (MUX) 302, a reference clock select MUX 304, a V.35 dataport clock source input 306, a chassis clock source input 308, a local clock source input 310, a DSL dataport clock source input 312, a E1 dataport clock source input 314, programmable dividers 316, 318, 322, an external phase detector and voltage controlled oscillator (VCO) 320 with a VCO clock output 344, a clock and data polarity control 326, a V.35 clock selection MUX 324, a G.SHDSL chipset NB dataport 336, a G.SHDSL chipset DSL dataport 338, a V.35 dataport 340, a E1 dataport 342, a G.SHDSL chipset NB dataport clock output 328, a G.SHDSL chipset DSL dataport clock output 330, a V.35 dataport clock output 334, and a E1 dataport clock output 332.

The master clock select MUX 302 and the reference clock select MUX 304 are coupled to the clock source inputs (the chassis clock source input 308, the local clock source input 310, the DSL dataport clock source input 312, and the E1 dataport clock source input 314). Additionally, the reference clock select MUX 304 is coupled to the V.35 clock source input 306 and the master clock select MUX 302 is coupled to the VCO clock output 344. The output of the reference clock select MUX 304 is coupled to the external phase detector and VCO 320 through the programmable divider 316. The output of the external phase detector and VCO 320, in addition to being coupled to an input of the master clock select MUX 302, is coupled to the programmable dividers 322 and 318. The output of the programmable divider 318 is coupled to the external phase detector and VCO 320 closing the phase detection loop of the external phase detector and VCO 320. The output of the programmable divider 322 is coupled to an input of the V.35 clock selection MUX 324. The V.35 dataport clock source input 306 is coupled to another input of the V.35 clock selection MUX 324 through the clock and data polarity control 326. The output of the V.35 clock selection MUX 324 is coupled to the G.SHDSL chipset NB dataport clock output 328 of the G.SHDSL chipset NB dataport 336 and the V.35 dataport clock output 334 of the V.35 dataport 340 through the clock and data polarity control 326. The output of the master clock select MUX 302 is coupled to the E1 dataport clock output 332 of the E1 dataport 342 and the G.SHDSL chipset DSL dataport clock output 330 of the G.SHDSL chipset DSL dataport 338.

In operation the FPGA 300 block diagram circuit of FIG. 3 selects with master timing select MUX 302 a master clock source from the clock source inputs 306, 308, 310, 312, and 314 and directs it to the E1 dataport 342 and the G.SHDSL chipset DSL dataport 338. A clock source is selected with reference timing MUX 304, normally the same clock as selected by MUX 302, and after being divided by programmable divider 316 is sent to the external phase detector and VCO 320 where a synchronous clock signal synchronized to the selected reference clock source is generated after being processed through the programmable dividers 316 and 318. This synchronous clock signal is then divided to a selected frequency by the programmable divider 322 and utilized to drive the G.SHDSL chipset NB dataport 336 and the V.35 dataport 340 producing a datastream on the G.SHDSL chipset NB dataport 336 and the V.35 dataport 340 that is synchronous with the datastream on the E1 dataport 342 and the G.SHDSL chipset DSL dataport 338. This presents the G.SHDSL chipset (not shown) with two synchronous datastreams that it can merge to transceive out the G.SHDSL WAN dataport (not shown). It is noted that the programmable divider 322 in various embodiments can be adjusted to provide whatever fractional datastream is desired on the G.SHDSL chipset NB dataport 336 and the V.35 dataport 340 in 64 kHz steps to complement the datastream on the E1 dataport 342 and the G.SHDSL chipset DSL dataport 338.

As stated above, the FPGA 300 in one embodiment selects a reference clock source from the clock source inputs 306, 308, 310, 312, and 314 (the chassis clock source input 308, the local clock source input 310, the DSL dataport clock source input 312, the E1 dataport clock source input 314, or the V.35 clock source input 306) with the reference clock select MUX 304. In addition, the FPGA 300 selects a master clock source from the clock source inputs 308, 310, 312, 314, and 344 (the chassis clock source input 308, the local clock source input 310, the DSL dataport clock source input 312, the E1 dataport clock source input 314, or the VCO clock source input 344) with the master clock select MUX 302.

If the clock source input is selected from the chassis clock source input 308, the local clock source input 310, the DSL dataport clock source input 312, or the E1 dataport clock source input 314, the master clock select MUX 302 couples the selected master clock to the E1 dataport 342 and the G.SHDSL chipset DSL dataport 338 (to the G.SHDSL chipset DSL dataport clock output 330, and the E1 dataport clock output 332). The reference clock select MUX 304 couples the selected reference clock source to the programmable divider 316 which is programmed with the appropriate divider value to produce an 8 kHz clock signal from the selected reference clock source signal. The output of the programmable divider is coupled to the external phase detector and VCO 320, which uses it as an input to generate a reference clock signal output. The reference clock signal output of the external phase detector and VCO 320 is coupled to the programmable divider 318 which is programmed with an appropriate divide value to produce an 8 kHz clock signal from the reference clock signal output of the external phase detector and VCO 320. The 8 kHz clock signal of the programmable divider 318 is coupled back into the external phase detector and VCO 320 to close the external phase detector and VCO's 320 feedback loop, allowing the external phase detector and VCO 320 to produce a reference clock signal output that is synchronized with the selected master clock signal. This synchronized reference clock signal output is coupled to the programmable divider 322 that is programmed with a selected divide value that produces the desired G.SHDSL chipset NB dataport 336 and the V.35 dataport 340 datastream.

The synchronized data clock signal that is produced by the programmable divider 322 is coupled through the V.35 clock selection MUX 324 to provide the desired clock signal for the G.SHDSL chipset NB dataport 336 (to the G.SHDSL chipset NB dataport clock output 328) and to the V.35 dataport 340 (to the V.35 dataport clock output 334) through the clock and data polarity control circuit 326. The clock and data polarity control circuit 326 adjusts the V.35 dataport 340 signals for correct polarity, inverting or not inverting the signals as required for data transport from the V.35 dataport 340. It is noted that multiple programmable dividers 322 could be utilized from the synchronized reference clock signal output of the external phase detector and VCO 320 to produce additional synchronized data clocks for additional datastreams if desired.

If the clock source input is selected from the V.35 dataport clock source input 306, the V.35 dataport is already synchronized to the reference clock as it is the source of the reference clock signal. In this situation it is the E1 dataport 342 and the G.SHDSL chipset DSL dataport 338 that must be synchronized and the master clock select MUX 302 couples the output of the external phase detector and VCO 320 to the E1 dataport 342 and the G.SHDSL chipset DSL dataport 338 (to the G.SHDSL chipset DSL dataport clock output 330, and the E1 dataport clock output 332). The reference clock select MUX 304 couples the V.35 dataport clock source input 306 to the programmable divider 316 which is programmed with the appropriate divider value to produce an 8 kHz clock signal from the V.35 dataport clock source input 306 clock signal. The output of the programmable divider is coupled to the external phase detector and VCO 320, which uses it as an input to generate a reference clock signal output. The clock signal output by the VCO 320 is coupled to the programmable divider 318 which is programmed with an appropriate divide value to produce an 8 kHz clock signal from the clock signal output by the VCO 320. The 8 kHz clock signal of the programmable divider 318 is coupled back into the external phase detector and VCO 320 to close the external phase detector and VCO's 320 feedback loop, allowing the external phase detector and VCO 320 to produce a clock signal output that is synchronized with the V.35 dataport clock source input 306 clock signal. This synchronized clock signal output is coupled, as stated above, to the E1 dataport 342 and the G.SHDSL chipset DSL dataport 338 (to the G.SHDSL chipset DSL dataport clock output 330, and the E1 dataport clock output 332). The V.35 dataport clock source input 306 clock signal is coupled through the clock and data polarity control circuit 326 and the V.35 clock selection MUX 324 to provide the desired clock signal for the G.SHDSL chipset NB dataport 336 (to the G.SHDSL chipset NB dataport clock output 328) and to the V.35 dataport 340 (to the V.35 dataport clock output 334) through the clock and data polarity control circuit 326.

It is noted that other implementations of the FPGA of FIG. 3 are possible and include, but are not limited to an ASIC, a series of separate logic elements, a specific chipset, or a processor or processing device. It is also noted that other implementations of the FPGA circuit of FIG. 3 are possible and should be apparent to those skilled in the art with the benefit of the present disclosure.

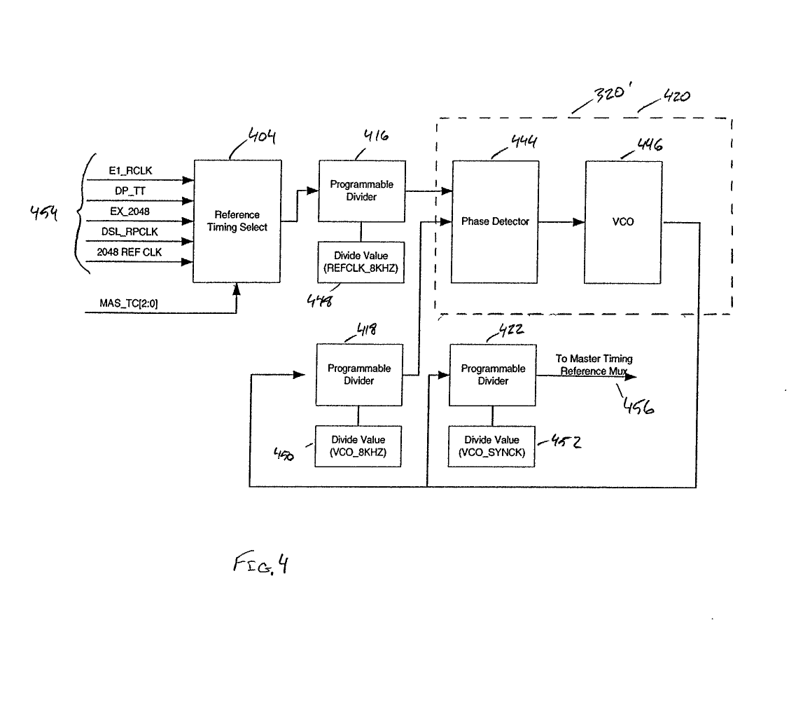

FIG. 4 details a simplified block diagram of one embodiment of a clock selection, recovery, division, and selection circuit containing clock source inputs 454, a clock output 456, a reference clock select MUX 404, programmable dividers 416, 418, 422, divider values 448, 450, 452, and a phase detector and VCO block 420, 320′. The phase detector and VCO block 420 contains a phase detector 444 and a VCO 446. The reference clock select MUX 404 is coupled to the clock source inputs 454 and to the programmable divider 416. The programmable divider 416 is coupled to the divide value 448 and has an output coupled to an input of the phase detector 444 of the phase detector and VCO block 420. The phase detector 444 is coupled in turn to the VCO 446. The VCO 446 produces the output of the phase detector and VCO block 420 and is coupled to the programmable dividers 418 and 422. The programmable divider 418 is coupled to the divide value 450 and has an output coupled to another input of the phase detector 444 of the phase detector and VCO block 420 closing the feedback loop of the phase detector and VCO block 420. The programmable divider 422 is coupled to the divide value 452 and is coupled to the clock output 456.

In operation, the clock selection, recovery, division, and selection circuit of FIG. 4 selects a clock source input 454 with the reference clock select MUX 404. The selected clock source is then divided by the programmable divider 416 with an appropriate divide value 448 to produce an 8 kHz signal synchronized with the reference clock. The 8 kHz reference clock is then used by the phase detector 444 to produce a drive signal for the VCO 446. The VCO 446 is designed to produce a selected output frequency that is divisible to an 8 kHz value. The output frequency of the VCO 446 is then divided by the programmable divider 418 using a selected divide value 450 to produce an 8 kHz VCO output clock signal. The divided 8 kHz VCO output clock signal is coupled back to the phase detector 444 to close the phase detector and VCO block 420 feedback loop and allows the phase detector 444 to adjust the VCO 446 to synchronize to the input 8 kHz reference clock signal and thus to the selected reference clock source 454. The synchronized VCO output clock of the VCO 446 is divided by the programmable divider 422 with the selected divide value 452 to produce the desired clock frequency synchronized to the selected reference clock source 454 on the clock output 456 for the circuit. In this manner a wide variety of clock sources and frequencies can be utilized to produce the desired synchronized clock output with the appropriate selection of programmable divider values and VCO frequency ranges.

It is noted that clock recovery circuits, such as that of the simplified block diagram of FIG. 4, can be designed in various embodiments to produce a synchronized clock signal that is a multiple of the reference clock source signal. It is also noted that other implementations of clock synchronization circuits can be utilized with embodiments of the present invention and include, but are not limited to, phase locked loops (PLLs) and digital locked loops (DLLs).

Alternative communications device embodiments of the present invention with an ability to merge and synchronized dataport datastreams will be apparent to those skilled in the art with the benefit of the present disclosure, and are also within the scope of the present invention.

### CONCLUSION

A communications device apparatus and method are described that allow for improved operation and reduced costs of network communication links and datastreams with an improved ability to merge and synchronize multiple WAN and LAN dataport datastreams. The improved communications device apparatus and method allows for a master data clock selection, a clock recovery, a derivate data clock division and a dataport data clock selection that allows for the generation of one or more synchronous derivative data clocks and the merging of multiple dataport datastreams for data transceiving. The improved communications device apparatus and method also allows for a master data clock to be recovered from a selected dataport and the other differing data rate dataports to be synchronized to it for the merging of multiple dataport datastreams for data transceiving.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of operating a telecommunications device with a plurality of dataports, comprising:
selecting a master clock signal from at least one clock source;
generating a synchronized reference clock signal from the master clock signal;
dividing the synchronized reference clock signal to generate at least one synchronized derivative clock signal;
coupling each at least one synchronized derivative clock signal to one or more of the plurality of dataports; and
transceiving data synchronized to the master clock signal on each of the plurality of dataports.

2. The method of claim 1, wherein at least one of the plurality of dataports is a synchronous dataport.

3. The method of claim 1, wherein the telecommunications device is a G.SHDSL compatible device.

4. The method of claim 1, wherein the plurality of dataports is selected from the group consisting of a V.35 interface, a G.SHDSL interface, a RS-232 interface, and a E1 interface.

5. The method of claim 1, wherein dividing the synchronized reference clock signal to generate at least one synchronized derivative clock signal further comprises dividing the synchronized reference clock signal by an integer value N to generate at least one synchronized derivative clock.

6. The method of claim 5, wherein the integer value of N is selected from the range of 1 to 36.

7. The method of claim 1, wherein dividing the synchronized reference clock signal to generate at least one synchronized derivative clock signal further comprises generating each at least one synchronized derivative clock signal as a multiple of 64 kHz.

8. The method of claim 1, further comprising:
coupling the transceived synchronized data from the plurality of dataports to and from an external network dataport.

9. The method of claim 8, wherein the external network dataport is a G.SHDSL dataport.

10. The method of claim 8, wherein a total of the data transceiving capability per unit of time of the plurality of dataports matches a data transceiving capability per unit of time of the external network dataport.

11. A method of operating a telecommunications device with a plurality of dataports, comprising:
selecting a master clock signal from at least one clock source;
dividing the master clock signal to generate at least one derivative clock signal;
synchronizing each of the at least one derivative clock signal to the master clock signal;
coupling each at least one synchronized derivative clock signal to one or more of the plurality of dataports; and
transceiving data synchronized to the master clock signal on each of the plurality of dataports.

12. A method of operating a communications device with a plurality of dataports, comprising:
recovering a master clock signal from a source dataport;
generating a synchronized reference clock signal from the master clock signal;
dividing the synchronized reference clock signal to generate at least one synchronized derivative clock signal;
coupling each at least one synchronized derivative clock signal to one or more of the plurality of dataports; and
transceiving data synchronized to the master clock signal on each of the plurality of dataports.

13. The method of claim 12, wherein the source dataport is selectable from a plurality of dataports.

14. A method of operating a G.SHDSL device, comprising:
recovering a master clock signal from a first dataport;
deriving a synchronized clock signal from the master clock signal;
coupling the synchronized clock signal to a second dataport;
transceiving data on the first dataport; and
transceiving data synchronized to the master clock signal of the first dataport on the second dataport.

15. The method of claim 14, further comprising:
coupling transceiving data on the first dataport and the transceived synchronized data from second dataport to and from a G.SHDSL interface.

16. The method of claim 14, wherein the first dataport is a E1 interface and the second dataport is a V.35 interface.

17. The method of claim 14, wherein deriving the synchronized clock signal further comprises deriving a synchronized clock signal that is equal to the master clock signal divided by an integer value N.

18. The method of claim 17, wherein the integer value of N is selected from the range of 1 to 36.

19. The method of claim 14, wherein deriving the synchronized clock signal further comprises deriving the synchronized clock signal as a multiple of 64 kHz.

20. The method of claim 15, wherein sum of the data transceiving bandwidth of the first and the second dataports is equal to the data transceiving bandwidth of the G.SHDSL interface.

21. A machine-usable medium having machine readable instructions stored thereon for execution by a processor of a telecommunications device to perform a method comprising:
receiving a master clock signal from a clock source;
deriving at least one synchronized clock signal from the master clock signal;
coupling each at least one synchronized clock signal to one or more of the plurality of dataports; and
transceiving data synchronized to the master clock signal on each of the plurality of dataports.

22. The machine-usable medium of claim 21, wherein the clock source is selectable from a plurality of clock sources.

23. The machine-usable medium of claim 21, wherein the telecommunications device is a G.SHDSL compatible device.

24. The machine-usable medium of claim 21, wherein the plurality of dataports is selected from the group consisting of a V.35 interface, and a E1 interface.

25. The machine-usable medium of claim 21, wherein deriving at least one synchronized clock signal further comprises deriving at least one synchronized clock signal that is equal to the master clock signal divided by an integer value N.

26. The machine-usable medium of claim 25, wherein the integer value of N is selected from the range of 1 to 36.

27. The machine-usable medium of claim 21, wherein deriving at least one synchronized clock signal further comprises deriving each at least one synchronized clock signal as a multiple of 64 kHz.

28. The machine-usable medium of claim 21, further comprising:
coupling the transceived synchronized data from the plurality of dataports to and from an external network dataport.

29. The method of claim 28, wherein the external network dataport is a G.SHDSL dataport.

30. The method of claim 28, wherein a total of the data transceiving capability per unit of time of the plurality of dataports matches a data transceiving capability per unit of time of the external network dataport.

31. A communications device, comprising:
a plurality of local interfaces; and
a master clock source, where at least one synchronized clock signal is generated from the master clock source and where each at least one generated synchronized clock signal coupled to one or more of the plurality of local interfaces to transceive data synchronized to the master clock source on each of the plurality of local interfaces.

32. The communications device of claim 31, wherein the master clock source is selectable from a plurality of clock sources.

33. The communications device of claim 31, wherein the communications device is a G.SHDSL compatible device.

34. The communications device of claim 31, wherein the plurality of local interfaces is selected from the group consisting of a V.35 interface, and a E1 interface.

35. The communications device of claim 31, wherein the at least one synchronized clock signal further comprises generating at least one synchronized clock signal that is equal to the master clock source divided by an integer value N.

36. The communications device of claim 35, wherein the integer value of N is selected from the range of 1 to 36.

37. The communications device of claim 31, wherein the at least one generated synchronized clock signal is a multiple of 64 kHz.

38. The communications device of claim 31, further comprising:
an external interface, where the external interface transceives data from an external communication link to the plurality of local interfaces.

39. The communications device of claim 38, wherein the external interface is a G.SHDSL interface.

40. The communications device of claim 38, wherein a total of data transceived on the local interfaces per unit of time is matched to the data transceived per unit of time on the external interface.

41. A telecommunications device, comprising:
a plurality of local interfaces; and
a source clock, where the source clock is recovered from a local interface of the plurality of local interfaces and at least one synchronized clock signal is generated from the source clock and coupled to one or more of the plurality of local interfaces to transceive data synchronized to the source clock on each of the plurality of local interfaces.

42. A G.SHDSL communications device, comprising:
a G.SHDSL interface;
a first interface; and
a second interface, where a source clock is recovered from the second interface and a synchronized clock signal is generated from the source clock and coupled to first interface to transceive data synchronized to the source clock of the E1 interface, where data transceived from the second and first interfaces is transceived to the G.SHDSL interface.

43. The G.SHDSL communications device of claim 42, wherein the first interface is a V.35 interface and the second interface is a E1 interface.

44. The G.SHDSL communications device of claim 42, wherein the synchronized clock signal is generated to equal to the master clock signal divided by an integer value N.

45. The G.SHDSL communications device of claim 44, wherein the integer value of N is selected from the range of 1 to 36.

46. The G.SHDSL communications device of claim 42, wherein the synchronized clock signal is generated as a multiple of 64 kHz.

47. The G.SHDSL communications device of claim 42, wherein sum of the data transceived on of the first and the second interfaces per unit of time is equal to the data transceived per unit of time on the G.SHDSL interface.

48. A In a telecommunications device having a plurality of local interfaces, and an external interface coupled to the plurality of local interfaces, a multiple interface clock synchronization method, comprising:
receiving a master clock signal from a clock source;
deriving at least one synchronized clock signal from the master clock signal;
coupling each at least one synchronized clock signal to one or more of the plurality of dataports; and
transceiving data synchronized to the master clock signal on each of the plurality of dataports.

49. A method of operating a G.SHDSL device with a plurality of dataports, comprising:
selecting a master clock signal from at least one clock source;
generating a synchronized reference clock signal from the master clock signal;
dividing the synchronized reference clock signal to generate at least one synchronized derivative clock signal;
coupling each at least one synchronized derivative clock signal to one or more of the plurality of dataports; and
transceiving data synchronized to the master clock signal on each of the plurality of dataports.

50. The method of claim 49, wherein at least one of the plurality of dataports is a synchronous dataport.

51. The method of claim 49, wherein the plurality of dataports is selected from the group consisting of a V.35 interface, a G.SHDSL interface, a RS-232 interface, and a E1 interface.

52. The method of claim 49, wherein dividing the synchronized reference clock signal to generate at least one synchronized derivative clock signal further comprises dividing the synchronized reference clock signal by an integer value N to generate at least one synchronized derivative clock.

53. The method of claim 52, wherein the integer value of N is selected from the range of 1 to 36.

54. The method of claim 49, wherein dividing the synchronized reference clock signal to generate at least one synchronized derivative clock signal further comprises generating each at least one synchronized derivative clock signal as a multiple of 64 kHz.

55. The method of claim 49, further comprising:
coupling the transceived synchronized data from the plurality of dataports to and from an external network dataport.

56. The method of claim 55, wherein the external network dataport is a G.SHDSL dataport.

57. The method of claim 55, wherein a total of the data transceiving capability per unit of time of the plurality of dataports matches a data transceiving capability per unit of time of the external network dataport.

58. A G.SHDSL communications device, comprising:
a plurality of local interfaces; and
a reference clock source, where at least one synchronized clock signal is generated from the reference clock source and where each at least one generated synchronized clock signal coupled to one or more of the plurality of local interfaces to transceive data synchronized to the reference clock source on each of the plurality of local interfaces.

59. The G.SHDSL communications device of claim 58, wherein the reference clock source is selectable from a plurality of clock sources.

60. The G.SHDSL communications device of claim 58, wherein the plurality of local interfaces is selected from the group consisting of a V.35 interface, and a E1 interface.

61. The G.SHDSL communications device of claim 58, wherein the at least one synchronized clock signal further comprises generating at least one synchronized clock signal that is equal to the master clock source divided by an integer value N.

62. The G.SHDSL communications device of claim 61, wherein the integer value of N is selected from the range of 1 to 36.

63. The G.SHDSL communications device of claim 58, wherein the at least one generated synchronized clock signal is a multiple of 64 kHz.

64. The G.SHDSL communications device of claim 58, further comprising:
an external interface, where the external interface transceives data from an external communication link to the plurality of local interfaces.

65. The G.SHDSL communications device of claim 64, wherein the external interface is a G.SHDSL interface.

66. The G.SHDSL communications device of claim 64, wherein a total of data transceived on the local interfaces per unit of time is matched to the data transceived per unit of time on the external interface.
